(19) United States
(12) Patent Application Publication
(10) Pub. No.: US 2005/0131776 A1
(43) Pub. Date: Jun. 16, 2005

(54) Virtual shopper device

(75) Inventors: Jennifer C. Perotti, Pittsford, NY (US); Steven S. Chapman, Corfu, NY (US); Dan Harel, Rochester, NY (US); Kathleen M. Costello, Rochester, NY (US); Dana W. Wolcott, Honeoye Falls, NY (US); Wilbert F. Janson, JR., Shortsville, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 10/736,351

(22) Filed: Dec. 15, 2003

(51) Int. Cl. G06F 17/60

(52) U.S. Cl. 705/27

(57) ABSTRACT

A virtual shopper devices and methods are provided for presenting to a user an image display of the user wearing an item. The virtual shopper device has an image display, a sensor for sensing signals from a tracking memory associated with the item, a memory device containing personal profile information for the user including at least one dataset composed of user fit data and user image data and a user input device for at least activating a function to present an image of the user wearing the item. A controller is also provided and is adapted to retrieve item fit data and item image data for the item from a database, to generate a display image simulating the appearance of the item as worn by the user, said display image being generated based upon the item fit data, the item image data, the user fit data and the user image data and to cause the image display to present the generated image.

### FIELD OF THE INVENTION

The present invention relates to a system and a method for virtual shopping for clothing or other wearable items of interest which permits user, via a hand held device, to view articles of clothing on an image of a shopper from various perspectives, and more particularly, to an automatic system and a method for fitting articles of clothing on a real image of user while also enabling notifications of other recommendations for a selected garment based upon such criteria as garments selected, body type, previous purchases, and personal shopper database stored both in the hand held device and by the clothing retailer.

### BACKGROUND OF THE INVENTION

Window shopping, whether done in person at a clothing retailer or by simply browsing a clothing catalog, has always had one inherent drawback in the difficulty or inability to try the clothing on before being purchased. A shopper would obviously prefer to be able to try on the article of clothing before purchase in order to examine the fit and size of the article of clothing on the body of the individual user. Often, however, it is very crowded, untimely and inconvenient to try on clothing at the retailer and impossible when shopping from a catalog. For example, models in catalogs or in a retailer display tend to be taller and thinner than most purchasers, thus developing high expectations for the garment appearance. A garment worn by a person not having model-type proportions might look quite different and might not be flattering. Moreover, a garment that is photographed in a catalog or tried on under studio or dressing room lights may have quite a different coloring and reflectivity in other settings, such as day light, candle light, office lighting, and so forth. A person's coloring also affects whether a particular garment is appropriate.

Furthermore, the manner of photographing a garment for a catalog, typically in a front pose, does not demonstrate back and side fit, and the flow of the garment in various activities. Fitting rooms attempt to solve the problem of front, back and side views by using multiple mirrors. Even so, observing the back view of one's self in a fitting room can be awkward. Further, fitting rooms obviously do not easily permit much testing of a garment in an active situation, or observance of a garment from a distance or in other settings, and observance by several individuals of whose opinion user 28 values. It is desirable, nevertheless, for a potential purchaser to observe the fit of a garment on themselves from various perspectives.

Additionally, clothing purchased for a different person, such as for a gift, cannot be tried on before the purchase. There is no practical way to preliminarily ascertain whether a particular garment will be flattering when worn.

Various methods and systems for illustrating the look of a garment on a particular person have been attempted. U.S. Pat. No. 6,307,568, by Rom, discloses a method of displaying garments, over the internet, as though draped over the body of a user which requires access to a web-page on the internet or the intervention of a third party, such as at point of sale terminal, to view the garment. U.S. Pat. No. 6,404,426, by Weaver, discloses a method and system for generating a three-dimensional reproduction of a model showing the fit of garments in various poses and environments, and can be accessed from a host computer via a direct connection or the internet. Further, the garment or model data can be provided to user 28 via a periodic diskette such as in a catalog.

U.S. Pat. No. 5,850,222, by Cone, has attempted a “virtual dressing room”, in which a person's measurements are used to create a body data structure that represents the person's figure, by adjusting a standard body data structure. Unfortunately, a garment is represented by a two-dimensional image of the garment worn by a physical mannequin; the garment is inaccurately “stretched” to approximate the adjusted body structure, rather than representing the actual garment.

An on-line clothing catalog by Land's End, available at www.landsend.com, is another example of a two-dimensional, static representation of a personalized model wearing clothing specified by the user. The static, two-dimensional nature of the model neither permits various viewpoints of the model during activity nor observation of the garment's reaction to the environment.

U.S. Pat. No. 6,415,199, by Liebermann, and U.S. Pat. No. 5,557,527, by Kotaki et al., concerns the mapping of a simulated garment, such as a body suit on a real or virtual mannequin, for use in conjunction with designing garments. While Liebermann uses the human form, the loop simulation image of Kotaki is dragged and distorted to fit over a scanned-in model of a person. Thus, although Kotaki starts with an accurate representation of a garment, the drawbacks of Cone are magnified in Kotaki. Additionally, Kotaki does not address the accurate representation of a person.

Other methods have attempted to compare garment measurements to standardized or personalized sizes. For example, in U.S. Pat. No. 5,530,652, by Croyle et al., a person and clothing are separately measured by a machine vision system. The data can be used to determine whether the garments are within tolerances, or to determine the best size of a particular piece of clothing for a person.

In a different field of application, computers have been used to study fabric characteristics, such as friction and wear. For example, in U.S. Pat. No. 5,495,568, by Beavin, a three dimensional model moves, such as raising the arms, bending, walking or running, and the response of a fabric model to motion, stretching and friction is evaluated. Computers have also been used to create and alter garment patterns to fit standard or individualized body measurements, as in U.S. Pat. No. 4,926,344, by Collins et al.

It will be appreciated that most users are particularly cautious about sharing personal profile information such as fit data about themselves. Such users are particularly cautious when sharing such data information with retailers as may then use this data for unexpected purposes. Therefore, there is an unmet need for, and it would be highly useful to have, a method and a system which displays, an image of an article of clothing or other wearable item such as jewelry, glasses, prosthetic devices, and the like as it would appear on the body of the user, according to the dimensions of the body of the user, while also ensuring that a user's personal information is not used for unexpected purposes. It is further desirable to provide a system that allows a user to select color or style variations for a particular article of clothing, as well as to locate and order items having the selected variations.

### SUMMARY OF THE INVENTION

A virtual shopper device is provided for presenting to a user an image display of the user wearing an item. The virtual shopper device has an image display, a sensor for sensing signals from a tracking memory associated with the item, a memory device containing personal profile information for the user including at least one dataset composed of user fit data and user image data and a user input device for at least activating a function to present an image of the user wearing the item. A controller is also provided and is adapted to retrieve item fit data and item image data for the item from a database, to generate a display image simulating the appearance of the item as worn by the user, said display image being generated based upon the item fit data, the item image data, the user fit data and the user image data and to cause the image display to present the generated image.

In another aspect of the invention, an electronic memory accessory is provided. The electronic memory accessory has stored therein personal profile information for a user including at least one dataset composed of user fit data and user image data and executable instructions for causing a programmable device to retrieve item fit data and item image data for an item and to generate a display image simulating the appearance of the item as worn by the user; said display image being generated based upon the item fit data, the item image data, the user fit data and the user image data. A memory interface is also provided. The memory interface is adapted to receive requests from the programmable device for the at least one dataset stored in the memory and wherein the memory interface allows data to be read from the at least one dataset only where the memory interface receives a signal indicating that programmable device is executing the executable instructions and wherein the executable instructions are adapted to prevent retention of the received data by the programmable device after the received data has been used by the executable instructions to generate an image.

In yet another embodiment of the invention, an image-processing device is provided. The image processing device has a memory with personal profile information for a user including at least one dataset composed of user fit data and user image data; a communication module adapted to receive item fit data, item image data, and an image signal; and a signal processor. The signal processor is adapted to process the received image signal to generate a display image signal based upon the user fit data, user image data, the item fit data and the item image data; wherein the generated display image signal is transmitted by the communication module.

In still another embodiment, a shopping system is provided. The shopping system has a database including information for at least one item which includes at least one of available size, style, color and fit information of the at least one item and corresponding image data for the at least one item; a programmable device having a communication circuit, a controller, an image display, and an input device; and a data storage device containing a communication module and downloadable information. The downloadable information has information for requesting and retrieving item image data and item fit data from a database and personal profile information for the user including at least one dataset composed of user image data and user fit data. The data storage device, allows the user to employ the personal computing device to request and retrieve, from the database, item image data and item fit data, to generate a display image simulating the appearance of the item as worn by the user based upon the item image data, the item fit data, the user image data and the user fit data and to display the generated image on a display of the programmable device.

In a further embodiment of the invention, a method is provided for presenting an image of a user wearing an item. In accordance with the method, personal profile information is obtained which includes at least one dataset of user fit data and user image data, and a tracking memory having information regarding the item is sensed. Item fit data and image data for the item is retrieved from a database using the information from the tracking memory. A display image is generated based upon the item fit data, item image data, user fit data, and user image data, and presenting the display image. The personal profile information is not provided to the database.

### BRIEF DESCRIPTION OF THE DRAWINGS

FIG. 1 illustrates a virtual shopper device according to one embodiment of the invention;

FIG. 2 illustrates a flow chart of one embodiment method of the invention;

FIG. 3A-3B illustrate a method and system for displaying clothing garments on a user utilizing the virtual shopper device of the invention either while “window shopping” at a retailer or “browsing” a catalog;

FIG. 4 illustrates a chart of a method for forming a revised image;

FIG. 5 illustrates the use of a virtual shopper device for shopping using a catalog;

FIG. 6 shows another embodiment of a virtual shopper device; and

FIG. 7 shows yet another embodiment of a virtual shopper device.

### DETAILED DESCRIPTION OF THE INVENTION

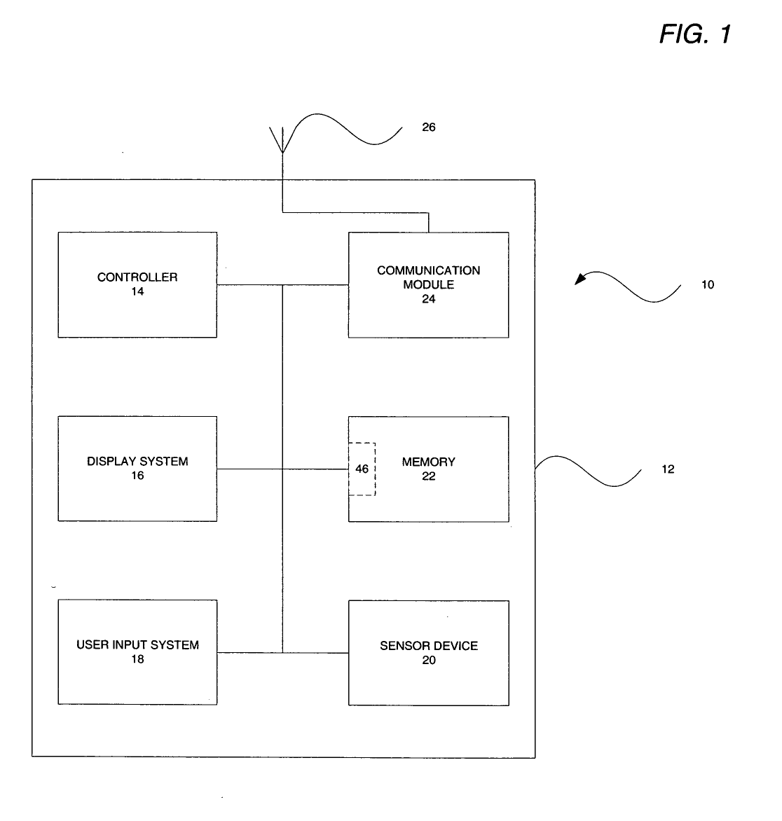

FIG. 1 generically illustrates a virtual shopper device 1 of one embodiment of the invention. In this embodiment, virtual shopper device 10 includes a housing 12 holding a controller 14, a display 16, a user input system 18, a sensor device 20, a memory 22 and a communication module 24 with an associated antenna 26.

Controller 14 can comprise a micro-processor, micro-controller, programmable analog device or any other logic circuit capable of cooperating with display system 16, a user input system 18, a sensor device 20, a memory 22 and a communication module 24 for performing the functions described in greater detail herein below.

A user 28 interacts with virtual shopper device 20 using display system 16 and user input system 18. Display system 16 is adapted to receive signals from controller 14 and to present images that can be observed by user 28 based upon the received signals. These images can comprise text, graphics, pictorial images, symbols, and any other form of visually detectable information. In this regard, display system 16 can comprise, for example, a color liquid crystal display, an organic light emitting display (OLED) a.k.a. an organic electro-luminescent display (OELD), or other conventional display device, and optional driving circuitry such as a conventional display driver.

User input system 18 is adapted to sense a user input action and to generate signals that can be used by controller 14 in controlling the operation of virtual shopper device 20. This allows user 28 to provide information, instructions, commands and other inputs to controller 14. User input system 18 can take any of a number of forms, which can include but are not limited to function keys, a keyboard, stand alone buttons, joystick systems, multiple direction switches, soft keys on display 16, voice recognition systems, gesture recognition systems, stylus systems, track ball systems and the like.

Virtual shopper device 20 of FIG. 1 also incorporates a sensor device 20 which is adapted to obtain information from at least one tracking memory that is associated with at least one item 34 that is available. As will be described in greater detail below, sensor device 20 can take on a variety of forms, such as a memory reader for reading solid-state or other types of memory, a light sensor such as a bar code or infrared scanner, or a radio frequency sensing system.

Virtual shopper device 20 also has at least one memory 22. In the embodiment shown, memory 22 stores the user personal profile data for at least one person such as the user of virtual shopper device 20. Memory 22 can also be used for other purposes including but not limited to storing software instructions for execution by a micro-processor embodiment of controller 14, for storing personal profile data for persons other that the user. Memory 22 can be incorporated within virtual shopper device 10 and/or separate from virtual shopper device 10 but operatively connected thereto by way of a communication network.

An optional communication module 24 is provided to enable communication between virtual shopper device 20 and a database 30. In the embodiment shown in FIG. 1, communication module 24 cooperates with an antenna 26 to enable wireless communication between virtual shopper device 20 and database 30. However, communication module 24 can take other forms. Communication module 24 can comprise, for example, a telecommunication interface such as a cellular telephone communication system interface, a conventional telephone interface, an Ethernet interface, or any other conventional communication circuit or system for communication directly with database 30 or for communication with database 30 using a network (not shown) such as a cellular or conventional telephone system, a wired or wireless local area network or wide area network or any other communication network.

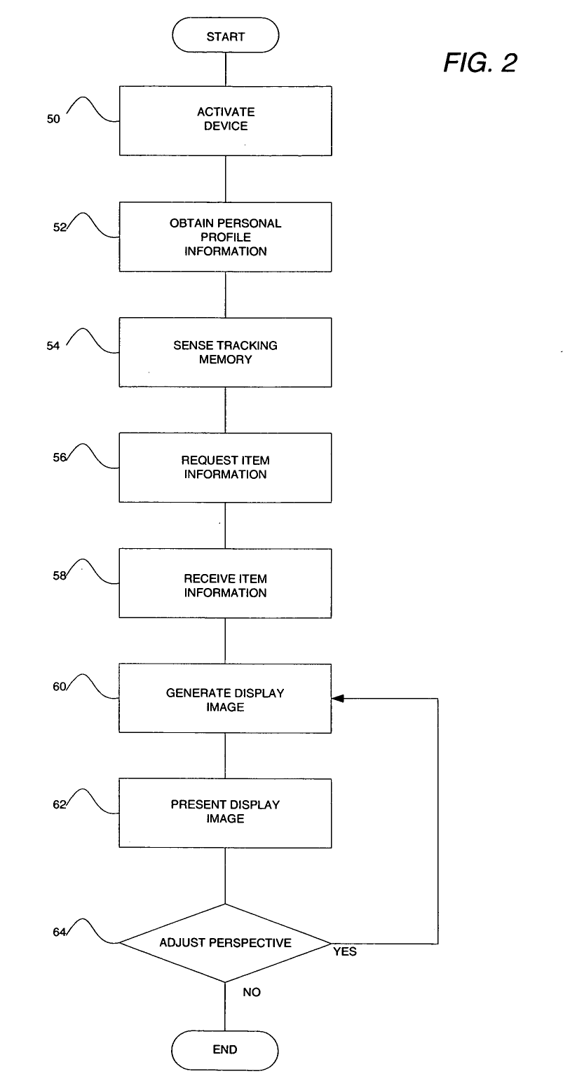

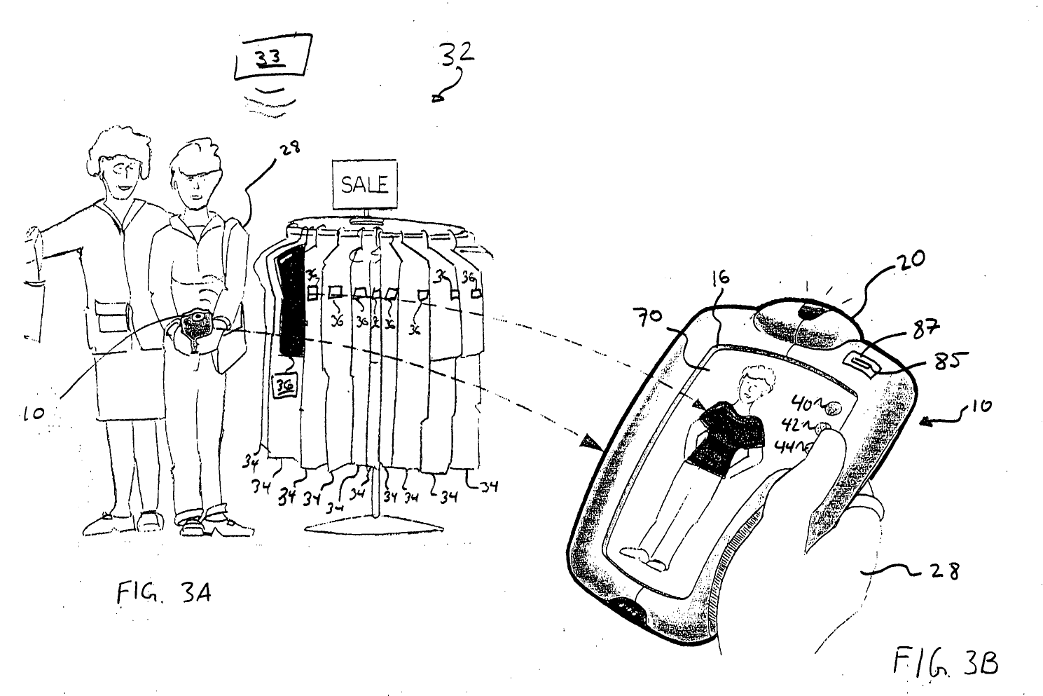

FIG. 2 shows a flow diagram of embodiment of a method for generating an image of a user 28 wearing an item 34 using virtual shopper device 10 in a retail environment 32 as illustrated in FIGS. 3A and 3B. Specifically, in FIG. 3A a user 28 is shown using virtual shopper device 10 while moving through a retail environment 32 such as a store having at least one item 34 stored for example on a rack or-on a model. In this illustration, the at least one item 34 comprises a wearable item of clothing. However, in other embodiments, item 34 can take other forms, for example, item 34 can comprise any wearable item such as eyewear, athletic equipment, prosthetic equipment, protective equipment, clothing, shoes, makeup, jewelry, and the like.

Each item 34 is associated with a tracking memory 36. Tracking memory 36 is a tangible item having data associated therewith that can be sensed by sensor device 20. Accordingly, sensor device 20 and tracking memory 36 are co-designed for such cooperation. Examples of such a co-designed sensor device 20 and tracking memory 36 include an example embodiment wherein the tracking memory 36 comprises a radio frequency identification transponder (not shown) of the type having a memory (not shown) with identification and/or other data stored therein, and a communication circuit. In the embodiment of FIG. 1, the communication circuit is of the type that generates a radio-frequency signal based upon the data stored in the memory.

Such a communication circuit typically generates radio-frequency signal when the communication circuit detects a polling signal transmitted by the sensor device 20. Alternatively, the communication circuit in tracking memory 36 can periodically transmit a signal based upon the data. In either alternative, sensor device 20 receives a signal generated by the communication circuit, extracts data therefrom, and provides the extracted data for use by controller 14. Such a radio frequency embodiment can be used in a way that offers the advantage of non-directional communication capabilities in that the virtual shopper device 10 need not be directed toward at tracking memory 36 in order to obtain information therefrom. However, where it is deemed advantageous, such a radio frequency embodiment can be provided in a way that allows user 28 to communicate with tracking memory 36 in a directional fashion. In this way, user 28 can direct sensor device 20 toward a particular item 34 to obtain information from a tracking memory 36 associated with particular item 34. Other forms of communication circuits can be used, for example, tracking memory 36 can comprise an optical transponder generating an optical signal such as a visible light signal infrared or ultra-violet range signal.

In another embodiment, tracking memory 36 comprises an article such as a tag having an optically readable in code thereon such as printed text, an image, a watermark, a bar code, or other encodement. In this embodiment, sensor device 20 comprises an optical scanner adapted to read the printed text, image, watermark, bar code, or other encodement. Such a signal can be detected by a co-designed reader device 20.

In still another embodiment, tracking memory 36 can comprise a readable memory device that records information in a form that is electronically, or magnetically readable. A first example embodiment of this type, tracking memory 36 can comprise a semiconductor memory having data stored therein. In another example embodiment, tracking memory 36 can comprise a magnetic memory surface such as a magnetic stripe having data stored thereon in the form of a magnetic pattern. In either such embodiment, tracking memory 36 and sensor device 20 will be adapted to obtain data from such a tracking memory 36.

While sensor device 20 is shown in FIGS. 1 and 2B on a top edge of housing 12, sensor device 20 can be located at other positions on housing 12, or in certain embodiments, sensor device 20 can be located entirely within housing 12. For example, a radio frequency embodiment of sensor device 20 can be positioned completely inside of a housing 12 of virtual shopper device 10 so as not to be visible, while an infrared or other optical scanning embodiment of sensor device 20 can be located on the top edge as shown or a the back surface or other convenient surface of housing 12 of virtual shopper device 10.

As shown in FIG. 2, user 28 begins by activating virtual shopper device 10 (step 50). For example, in the illustration of FIGS. 3A and 3B, virtual shopper device 10 can be activated when user 28 provides appropriate instructions to user input system 18. In the embodiment shown in FIGS. 3A and 3B, user input system 18 includes a plurality of function keys 40, 42 or 44, shown as soft keys 38 on display system 16. User 28 can actuate one of function keys 40, 42 or 44 which cause a signal to be provided controller 14 in response to this to begin the process of the using sensor device 20 to detect at least one tracking memory 36 associated with an item 34.

Virtual shopper device obtains (step 52) a dataset of personal profile information for use in generating the image. The personal profile information includes an image data based upon the user 28 and fit data for user 28. The fit data can take a variety of forms and can comprise any type of information from which the size, dimensions, posture, build, and/or shape of user 28 can be determined and compared to complimentary fit data that will be obtained, as described below, for a particular item 34.

In one embodiment, virtual shopper device 10 comprises a device such as a cellular telephone, personal digital assistant, portable computer, or other device that is personally owned by shopper 28. In such embodiment, virtual shopper device 28 has a memory 22 with the personal profile information stored therein at the time that shopper 28 enters retail environment 32. Alternatively, such a personally owned virtual shopper device can obtain personal profile information from a remote memory 22 such as a database that can be accessed, for example, by a cellular telephone connection. In either embodiment, virtual shopper device 10 has a controller 14 that is adapted so as not to provide personal profile information to any external device without approval from user 28 and that is further adapted to form an image based upon the personal profile information is well as information received from a database 30 provided by an operator of the retail environment 32.

In another embodiment, virtual shopper device 10 can be provided by an operator of the retail environment 32. For example, virtual shopper device 10 can comprise a handheld or stationary device located in retail environment 32. In this embodiment, personal profile information can be obtained from a memory 22 such as a removable memory card or other memory device provided by user 28. However, in this embodiment, memory 22 incorporates a memory interface 46 that does not permit transfer of personal profile information without receiving a signal from a controller 14 indicating that the controller 34 is executing instructions that are adapted to prevent the retention of personal profile information after the received data has been used to generate an image.

It is also within the scope of the invention to be able to obtain personal profile information for persons other than user 28 for use in generating images. Such personal profile information for other persons can be stored in memory 22 or made available in other ways as described above. Accordingly, the step of obtaining personal profile information (step 52) can include the optional step of designating a person other than user 28 for whom personal profile information is to be obtained. User 28 can use user input system 18 such as by selecting one of the function keys 40, 42 and 44 shown as soft keys on the display to select personal profile information for another person. Personal profile information can then be obtained for the additional user. Once obtained personal profile data can optionally be buffered for ready use in forming an image.

A tracking memory 36 is sensed using sensor device 20 as described above (step 54). In one embodiment, this occurs when user 28 directs sensor device 20 at an item 34 or at a tracking memory 36 that is associated with an item and use user input system 18 to designate that user 28 has an interest in item 34. Controller 14 will cause sensor device 20 to obtain information from tracking memory 36.

Virtual shopper device 10 then automatically requests item information (step 56). This can be done in a variety of ways. For example, where 5 the retail environment 32 includes a communication system 33 such as a wireless local area network, communication module 24 and antenna 26 can be used to communicate using communication system 33 to request information regarding item 34 from database 30 based upon the information obtained from tracking memory 36. The request for item information can include a request for item information for only one item 34, a request for information for all items 34 having a similarity to an item of interest, for example, being of a consistent cut, fabric, finish or style. The request for information can also include a request for information that is not necessarily of interest to a user 28 but that can help to ensure that the request for information that user 28 provides does not reveal information that the user wishes to remain private. For example, the request can include a request for all sizes of a particular style and color of item 34 so that it cannot be determined from the request what is of interest to user 28. Database 30 obtains the requested information and in the embodiment shown, transmits this information using communication system 33 in manner that can be received by communication module 24 of virtual shopper device 10.

The item data provided by database 30 typically comprises item image data and item fit data. Other data related to an item 34 can also be provided. The item fit data can take a variety of forms and can comprise any type of information from which the size and/or fit of the item 36 can be compared to the user fit data for use in generating a display image. Item option data can also be provided. The item option data identifies other options that are available for purchase and that are similar to item 34. For example, item option data can include data that can be used to indicate that items that are similar to an item 34 of interest are available in other colors, sizes, fits, finishes, shapes, or other characteristics. This information can be used as will be described in greater detail below.

The response from database 30 is then received by communication module 24 (step 58) which provides information contained in the response to controller 14. Controller 14, in turn, generates a display image based upon the obtained item information and the personal profile information (step 60). Specifically, in this embodiment the item fit data and user fit data are compared. As a result of this comparison the image data for the item and the image data for the user are combined to form display image data comprising at least one image of the user wearing the item. By using the item fit data and the user fit data, the display image can provide a highly accurate representation of the appearance of item 34, as it will appear when worn by user 28 or another selected user.

Controller 14 then causes the display image to be presented as an image 70 by display system 16 (step 62). If the image is unavailable or if the comparison does not meet the requirements of the model image data, then the indication of expected fit would be a message indicating such on the display.

Once that image 70 is presented, (step 62) user 28 can adjust the perspective of the display image using user input system 18 to send perspective adjustment instructions to controller 14 (step 64). Where appropriate item information and user profile information are provided, the image can be rotated to provide a full 3600 change in perspective to see what the item looks like from many angles.

User 28 can also request, again using user input system 18, a menu of options for item 34. In a clothing example, options such as such as loose fit (large size), tighter fit (smaller size), different available colors, and different available styles (e.g., necklines, pullovers, etc.) can be made available. Upon selection of the option, controller 14 obtains a revised display image 72 item option data such as item image data or item fit data for the selected option from database 30 and generates. Revised display image 72 illustrates user 28 or other selected person wearing the item with the selected option. User 28 can then request from the retailer merchandise database, using a function key, an indication of availability and if not available place an order request in the retailer merchandise database for the revised item of clothing when it becomes available.

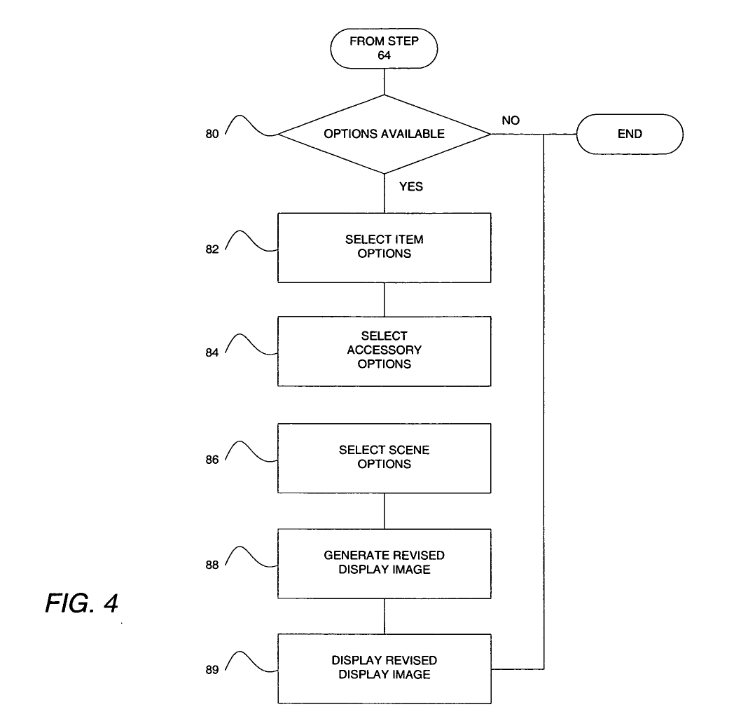

FIG. 4, illustrates a flow diagram of one embodiment of a method for forming a revised image 72. Specifically, user 28 upon viewing a display image (step 62) is provided with an opportunity to select options for the displayed item (step 80) via the user input system 18. User 28 is presented with several options for viewing changes to the display image. The preferred change options are 1) shopper selected options, 2) retailer suggested options and 3) virtual shopper device selected options. The display options can be based, at least in part, upon the personal profile information stored in memory 22, the retailer's database information, and the retailer's merchandise database.

Depending on the display option selected, user 28 would be presented with a series of selections, e.g., via menus, soft keys, for changes to the displayed image. For example, an option of available accessories (such as belts, jewelry, handbags), alternative styles (such as neckline, waistline), sizes (larger, smaller) or colors of the item, shoes and makeup, can be presented to user 28 on the display which are drawn at least in part from the personal profile information for user 28 stored in the memory 22.

Additionally, options can be provided for selecting ensemble, such as evening wear, sportswear, business wear or casual wear, and related items from the retailer's merchandise database can be presented to user 28 (step 84). Depending on the display option selected, the changes to user 28 image would be based at least in part upon at least one of the personal profile information stored in virtual shopper memory, the retailer's database information regarding user 28, and the retailer's merchandise database.

Further, a user can even select options for a background scene simulation, such as lighting effects (step 86). This can be done, for example, using preset lighting conditions or, alternatively, by selecting a scene from a database and determining lighting conditions from the image or image metadata in the image and using the determined lighting conditions to form the display image. In one useful embodiment of this type the scene image itself can be incorporated into the display image. A revised display image 72 is then formed based upon the selected options. (step 86) and (step 89).

The virtual shopping device 10 can be operated in a variety of other ways. For example, in one embodiment, virtual shopping device 10 can be used to help shopper 28 to detect when shopper 28 is within proximity of an item of interest. In this embodiment, controller 14 detects a signal from user input system 18 indicating that the user is seeking a particular item 36. Controller 14 can use sensor device 20 to perform a general scan of areas proximate to virtual shopper device 10 for a tracking memory 36 and can receive and process signals transmitted by one or more tracking memories 20. Item information is received for each item that is detected in this fashion and compared to the characteristics of the item of interest. When a match occurs controller 14 causes an image to be presented using display system 16 indicating the presence of an item having such a match.

For example, in another embodiment, controller 14 can be operated in a mode that merely detects each tracking memory 36 associated with items proximate to virtual shopper device 10 and can cause a listing of such items to be presented. If the user 28 desires to view a detected item, all that is necessary is for user 28 to select the “wear it” function using for example, one of the plurality of function keys 40, 42 or 44, designate item 36 and a display image 70 of user 28 wearing the item is presented using display system 16.

Virtual shopper device 10 can further be adapted to operate in cooperation with other systems provided in other retail environments. For example, the item information can also be stored in and communicated from the tracking memory 36 of the item 34 to virtual shopper device 10. Alternatively, item data can be stored in the device memory 22, i.e., retrieved from a data card or portable data storage device 85 provided by the retailer, such as upon entry to the retail establishment or via the mail, and inserted into a slot 87 in housing 12 of virtual shopper device 10. In another alternative, database 30 can be downloaded to the virtual shopper memory 22 via communication module 24, upon arrival at the retail environment 32. When an item 34 having particular options is unavailable at retail environment 32, controller 14 enables user 28 to create an order for the item, transmit the order to database 30 and receive confirmation of receipt of the order. Alternatively, controller 14 and communication module 24 can cooperate to obtain item information from other sources and can attempt to locate an item 34 having the desired options at other retailers.

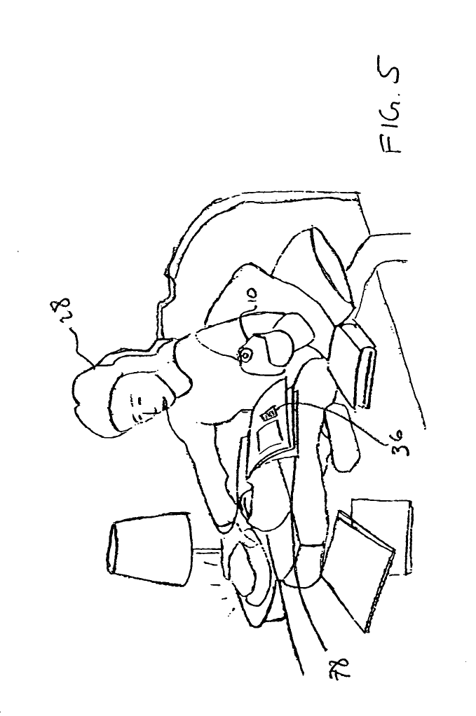

In another embodiment, each of the functions described above can by carried out while user 28 is “browsing” a catalog 78, as illustrated in FIG. 5. That is, when user 28 sees an item 34 in catalog 78 that is of interest, user 28 merely scans a bar code label text, watermark, or other encodement associated with item 34 in the catalog page and establishes a wireless or wired connection to the retailer using the function keys described above. The process of viewing the image of user 28 “wearing” the item of clothing is thereafter as described above.

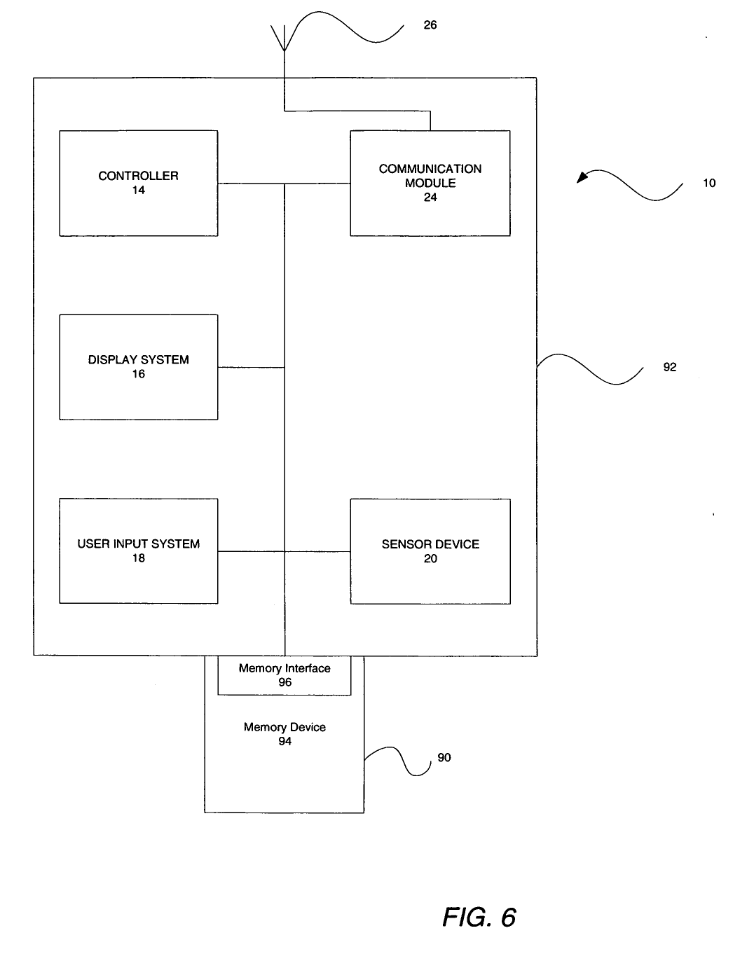

It will be appreciated that many programmable logic devices such as personal computers, personal digital assistants, and video game consoles have the capability to act as a virtual shopper device 10 if properly programmed. Accordingly, in other embodiments of the invention, virtual shopper device 10 can comprise a device capable of storing appropriate software and user's personal profile data, combined with a programmable device 92 such as any device capable of executing the software and having the necessary hardware for performing the functions described above. For example, the virtual shopper device 10 of FIG. 6 can be structured as an accessory 90 having a memory 94 containing the virtual shopper software and user personal profile data, which is connectable (wirelessly or through a wired connection) to a programmable device 92 such as a PDA, cellular phone, point-of-sale terminal, video game console, kiosk, home personal computer, or other programmable device. This embodiment enables the PDA, cellular phone, point-of-sale terminal, video game console, or home personal computer, when connected to the virtual shopper device and the virtual shopper software and user personal profile data is downloaded, to function as a fully functioning virtual shopper device described above.

Optionally, memory embodiment can be adapted to cooperate with a sensing system 20 for sensing tracking memories that are associated with items of interest so that user 28 can move about a retail environment, obtain data from the tracking memory 36 of each item of interest using the sensing system/memory 22 combination and can then connect the memory to a programmable device 92. When memory 94 is connected to the programmable device 92 and the virtual shopper software and user personal profile data is downloaded, this combination can function as a virtual shopper device 10 described above. As is shown in FIG. 6, memory 94 has a memory interface 96 adapted to receive requests from programmable device 92 for at least one dataset stored in the memory 94. Memory interface 96 is further adapted to allow data to be read from the at least one dataset only where the memory interface receives a signal indicating that programmable device is executing the executable instructions and wherein the executable instructions are adapted to prevent retention of the received data by the programmable device after the received data has been used by the executable instructions to generate an image.

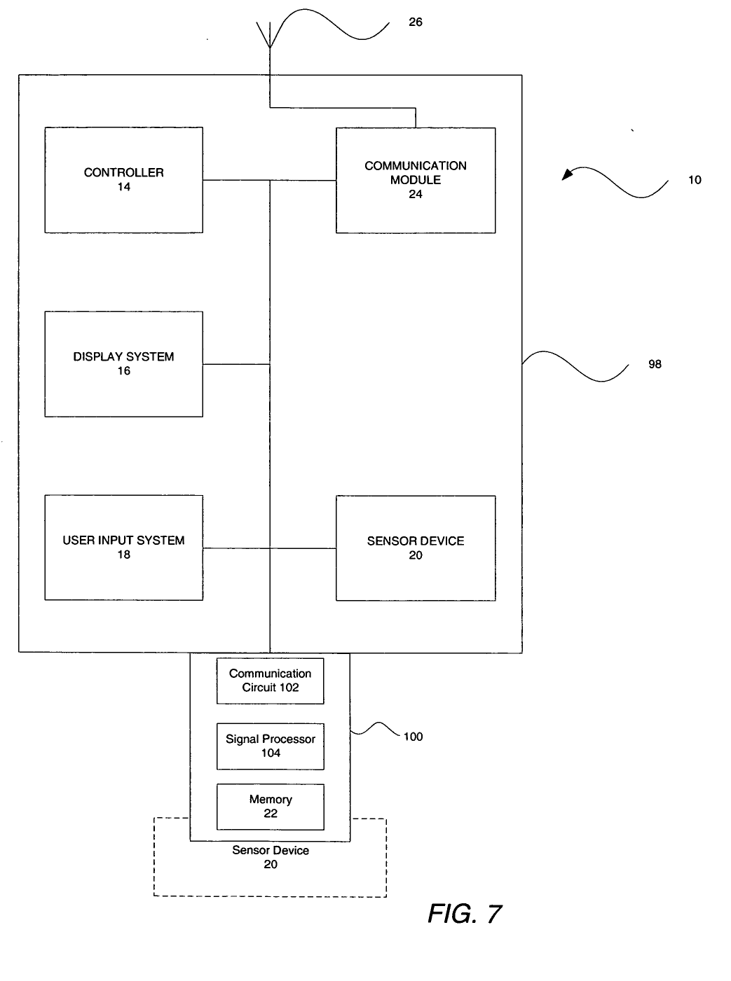

In still another embodiment of the invention shown in FIG. 7, the virtual shopper device 10 can comprise a device 98 such as a PDA, personal computer, point of sale terminal, kiosk or any other device that is adapted to functionally cooperate with an image processing device 100 provided by a user 28 and operate in the manner to be described below. In this embodiment, image processing device 100 comprises memory 22 having personal profile information for the user including at least one dataset composed of user fit data and user image data and a communication circuit 102 adapted to receive item fit data and item image data, and optionally, an image signal from controller 14. A signal processor 104 in image processing device 100 is adapted to process the received image signal and to generate at least a part of a display image based upon the user fit data, user image data, item fit data and item image data. In this embodiment, the generated display image is transmitted by communication circuit 102 to the device 98 for presentation using display system 16.

A retailer or other person can provide a structure that allows a user to identify items of interest, a database 30 having item information stored therein, and controller 14 that provides item information and other useful image data to the signal processor which then returns digital image data for presentation using display system 16. In this way, an accurate image of the item and a person can be formed and presented without downloading personal profile data for the person.

In one alternative embodiment, the image-processing device 100 can optionally comprise comprising a source of information for requesting and retrieving item information from a database. Such a source can comprise a sensor device 20 for reading a tracking memory 36 and storing item information from selected tracking memories 36 in memory 22. The personal profile information used by the signal processor 104 can include user image data, user fit data, and user personal preference information for preferred and non-preferred accessories, styles, sizes or colors of garments, shoes and makeup and the signal processor uses such preferences in forming the display image data.

Further, virtual shopper device 10 when constructed as an accessory such as the electronic memory accessory embodiment shown in of FIG. 6 or the image processing device 100 shown in FIG. 7, can be include one or more of the components described above but not available in the device 98 to which the accessory is attached. For example, an accessory embodiment can supply a sensor system 20 as noted above, a communication module 24 or other components of virtual, which are not available on a PDA, cellular phone, point-of-sale terminal, or home personal computer. Such an accessory has a minimum downloadable, virtual shopper software and user personal profile data capable of performing the functions described above. Thus, virtual shopper device 10 can be structured to operate in a symbiotic manner with the PDA, cellular phone, point-of-sale terminal, or home personal computer such that the virtual shopper software and user's personal profile data can be accessed and an image of the user “wearing” a selected garment can be displayed on the PDA, cellular phone, point-of-sale terminal, or home personal computer. This embodiment provides additional convenience to the user desiring to delay a purchase decision, wishing to see a larger view the user “wearing” the garment or desiring to carry only one portable computing device, i.e., PDA or cellular phone. This embodiment also ensures that personal profile information to remains in the PDA and is not transferred to a remote system.

While the invention has been described with a certain degree of particularity it is manifest that many changes may be made in the details of construction and the arrangement of components without departing from the spirit and scope of this disclosure. It is understood that the invention is not limited to the embodiments set forth herein for purposes of exemplification, but is to be limited only by the scope of the attached claim or claims, including the full range of equivalency to which each element thereof is entitled.

### Parts List

10 virtual shopper device
12 housing
14 controller
16 display system
18 user input system
20 sensor device
22 memory
24 communication module
26 antenna
28 user
30 database
32 retail environment
33 communication network
34 item
36 tracking memory
38 soft keys
40 function key
42 function key
44 function key
46 memory interface
50 activating step
52 obtain person profile step
54 sense tracking memory step
56 request item data step
58 receive item data step
60 generate display image step
62 present display image step
64 adjust perspective of display image step
70 display image
72 revised display image
78 catalog
80 display options step
82 select item options step
84 select accessory options step
85 portable data storage device
86 select scene options step
87 slot
89 display revised image step
90 accessory
92 programmable device
94 memory
96 memory interface
98 device
100 image processing device
102 communication circuit
104 signal processor

1. A virtual shopper device for presenting to a user an image display of the user wearing an item comprising:
an image display;
a sensor for sensing signals from a tracking memory associated with the item;
a memory device containing personal profile information for the user including at least one dataset composed of user fit data and user image data;
a user input device for at least activating a function to present an image of the user wearing the item; and
a controller adapted to retrieve item fit data and item image data for the item from a database, to generate a display image simulating the appearance of the item as worn by the user, said image data being generated based upon the item fit data, the item image data, the user fit data and the user image data, and to cause the image display to present the display image.

2. The virtual shopper device of claim 1, wherein the database is separate from the virtual shopper device and wherein the virtual shopper device further comprises a communication module for establishing communication with the database.

3. The virtual shopper device of claim 1, wherein the personal profile information further includes user personal preference information for preferred and non-preferred items.

4. The virtual shopper device of claim 1, wherein the personal profile information further includes personal preference information identifying at least one of a preferred item color, style, fit, and size.

5. The virtual shopper device of claim 1, wherein the controller permits the user to select options for the generated image based upon related item options stored in the database, obtains item option data for the selected item option from the database and generates a revised display image based upon the obtained item option data, the user fit data, and the user image data, and displays the revised display image.

6. The virtual shopper device of claim 5, wherein the controller further determines from the database, a location of an item having the selected item option.

7. The virtual shopper device of claim 1, wherein the personal profile information includes at least one dataset for an additional user which contains user fit data and user image data for the additional user, and wherein the controller permits the user to select the additional user dataset and enables generation and display of a display image of the item and the additional user based upon item fit data and item image data for the additional user.

8. The virtual shopper device of claim 1, further comprising a communication module to establish wired communication with the database for the retrieval of item fit data and item image data.

9. The virtual shopper device of claim 1, wherein the memory device further includes a slot for receiving a removable memory having the database stored thereon and wherein the controller is adapted to download item fit data and item image data from the database on the removable memory.

10. The virtual shopper device of claim 1, wherein, when the item having at least one of user selected item fit data, item image data, and item option data is unavailable at a particular retail establishment, the user input device and controller are adapted to enable the user to create an order for the user selected item, transmit the order to the database and receive confirmation of receipt of the order.

11. The virtual shopper device of claim 1, wherein the user input device comprises at least one dedicated function key, at least one soft key, a PDA-like keyboard or a stylus pad.

12. The virtual shopper device of claim 1, wherein the user input device and controller cooperate to permit the user to select at least one of scene options and accessory options for forming a revised display image and form a revised display image reflecting the selected options.

13. The virtual shopper device of claim 1, wherein the controller stores data for selected generated images in the memory device to allow each generated image to be presented later.

14. The virtual shopper device of claim 1, wherein the personal profile information further includes item fit data and item image data for a plurality of previously displayed generated images and a plurality of previously purchased items and wherein the user input device and the controller cooperate to permit the user to view a generated image of a previously purchased item on the display.

15. The virtual shopper device of claim 1, wherein the user input device is adapted to receive a change in perspective input action and the controller generates an image that simulates the appearance of the user and item as viewed from different perspectives.

16. The virtual shopper device of claim 1, wherein the controller prevents the database from obtaining image data personal fit data from the memory device.

17. The virtual shopper device of claim 1, wherein the controller accompanies each request for item fit data and item image data with a request for additional item fit data and item image data said additional request requesting item information that does not correspond to an item of interest to the user.

18. An electronic memory accessory comprising:
a memory having personal profile information for a user including at least one dataset composed of user fit data and user image data the memory further has executable instructions for causing a programmable device to retrieve item fit data and item image data for an item and to generate a display image simulating the appearance of the item as worn by the user; said display image being generated based upon the item fit data, the item image data, the user fit data and the user image data;
a memory interface adapted to receive requests from the programmable device for the at least one dataset stored in the memory and wherein the memory interface allows data to be read from the at least one dataset only where the memory interface receives a signal indicating that programmable device is executing the executable instructions and wherein the executable instructions are adapted to prevent retention of the received data by the programmable device after the received data has been used by the executable instructions to generate an image.

19. The electronic memory of claim 18, further comprising a source of information for requesting and retrieving from item fit data and item image data from a remote database.

20. The electronic memory accessory of claim 18, wherein the source of information comprises a reader device for reading a tracking memory.

21. The electronic memory accessory of claim 18, wherein the executable instructions comprise instructions for at least one of a personal digital assistant, personal computer, handheld computer, kiosk, or point of sale terminal.

22. An image processing device comprising:
a memory having personal profile information for a user including at least one dataset composed of user fit data and user image data;
a communication module adapted to receive item fit data, item image data, and an image signal; and
a signal processor adapted to process the received image signal to generate a display image signal based upon the user fit data, the user image data, the item fit data and the item image data;
wherein the generated display image signal is transmitted by the communication module.

23. The image processing device of claim 22, further comprising a source of information for requesting and retrieving item fit data and item image data from a database and wherein the memory is further adapted to store the information for requesting and receiving.

24. The image processing device of claim 23, wherein the source for information item fit data and item image data comprises a reader device for reading a tracking memory.

25. The image processing device after of claim 22, wherein the dataset includes at least one of information for assembling the image information of the item and information for displaying the generated display image.

26. The image processing device of claim 22, wherein the personal profile information further includes user personal preference information for preferred and non-preferred accessories, styles, sizes, finishes and colors of items.

27. The image processing device of claim 22, wherein the personal profile information includes at least one dataset for an additional user which contains user fit data and user image data for the additional user, and wherein the signal processor is adapted to receive a signal selecting one of the user datasets for use in generating the display image.

28. The image processing device of claim 22 wherein the memory has at least one of:
information to permit the user to select changes to the generated display image based upon item option data provided by the database, information for retrieving item option image data of the changes selected from the database; and
information for generating a revised display based upon the item option data with the image data of the user from the personal profile information, stored therein.

29. The image processing device of claim 22 wherein the memory further has information for using a wireless signal to communicate using a communication network connected to the database stored therein and,
wherein the information for requesting and retrieving from database includes information for wirelessly retrieving information from the database using the signal.

30. A shopping system comprising:
a database including information for at least one item which includes at least one of available size, style, color and fit information of the at least one item and corresponding image data for the at least one item;
a programmable device having a communication circuit, a controller, an image display, and an input device; and
a data storage device containing a communication module and downloadable information, the downloadable information comprising:
information for requesting and retrieving item image data and item fit data from the database; and
personal profile information for the user including at least one dataset composed of user image data and user fit data,
wherein the data storage device, allows the user to employ the programmable device to request and retrieve from the database item image data and item fit data, to generate a display image simulating the appearance of the item as worn by the user based upon the item image data, the item fit data, the user image data and the user fit data and to display the generated image on a display of the programmable device.

31. The shopping system of claim 30, further comprising a sensor for sensing a tracking memory associated with an item and obtaining data therefrom,
wherein the communication module of the personal computing device or the data storage device includes a device for establishing wireless communication with the database via a wireless network,
wherein the data storage device further includes information for use in sensing the tracking memory,
wherein the information for requesting and retrieving from a database includes information for wirelessly retrieving information from a database using a remote network, and
wherein, upon sensing a radio frequency or infrared signal, the information for requesting and retrieving allows the user to wirelessly request the garment information from the database.

32. A method for presenting an image of a user wearing an item comprising the steps of:
obtaining personal profile information which includes at least one dataset of user fit data and user image data,
sensing a tracking memory having information regarding the item;
retrieving fit data and image data for the item from a database using the information from the tracking memory;
generating a display image based upon the item fit data, item image data, user fit data, and user image data; and
presenting the display image
wherein the personal profile information is not provided to the database.

33. The method of claim 32, further comprising the steps of sensing more than one tracking memory with each tracking memory associated with an item, obtaining fit data for each item, and identifying at least one item of interest by detecting items having fit data that correspond to user fit data.

34. The method of claim 32, wherein the personal profile information further comprises at least one of style, color, and fit information and further comprising the steps of sensing more than one tracking memory each associated with an item, obtaining at least one of style, color, and fit data for each item, identifying at least one item of interest by detecting items having at least one of style color and fit data that correspond to at least one of the style, color and fit data in the personal profile.

35. The method of claim 32, further comprising the steps of determining options available for the item of interest, displaying information to a user indicating that such options are available, and forming a display image based upon such options.

36. The method of claim 35, further comprising the step of determining the nearest retail location having the item of interest available for purchase.
